(19) United States
(12) Patent Application Publication
(10) Pub. No.: US 2003/0005451 A1
(43) Pub. Date: Jan. 2, 2003

(54) Method and apparatus to distribute content descriptors in a content distribution broadcast system

(76) Inventor: Jay H. Connelly, Portland, OR (US)

Correspondence Address: James Y. Go, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/882,485

(22) Filed: Jun. 15, 2001

(51) Int. Cl. H04N 7/173

(52) U.S. Cl. 725/86; 725/24; 725/103

(57) ABSTRACT

Methods and apparatuses sending content descriptors from a server to a client in a content distribution broadcast system. In one aspect, a signal is sent prior to the sending of a content descriptor file. The signal indicates when the content descriptor file will be sent. In another aspect, a unique identifier is assigned to the content descriptor file by the server. The content descriptor file is sent to the client and the client identifies the content descriptor file by the unique identifier. In yet another aspect, a general purpose identifier is assigned to the the content descriptor file. The content descriptor file is sent to the client and then a signal is sent to the client afterwards indicating that the content descriptor file has been sent.

### BACKGROUND OF THE INVENTION

1. Field of the Invention

The present invention relates generally to broadcast systems and, more specifically, the present invention relates to providing content on demand in broadcast systems.

2. Background Information

Broadcast systems traditionally transmit data in one direction from a server system to a plurality of client systems. Users of the client systems typically consume the signals received from the server system as they are broadcast. One paradigm in which users are provided with content on demand involves server systems that broadcast the same data continuously and/or at staggered intervals. Thus, if a user desires to consume a particular piece of content or data file on demand, the user “tunes in” to one of the repeated broadcasts of the content. One example of this paradigm can be illustrated with present day “pay per view” movies that are available from cable or satellite television providers. For instance, cable television providers commonly broadcast the same movies repeatedly on multiple channels at staggered intervals. Users that wish to watch a particular movie “on demand” simply tune in to one of the channels on which the desired movie is broadcast at the beginning of one of the times that the movie is broadcast. The continuous and repeated broadcasts of the same data or programs results in a very inefficient use of broadcast bandwidth. Bandwidth used to broadcast the same data repeatedly on multiple channels could otherwise be used to broadcast different data.

Another paradigm for providing content on demand in a broadcast system involves a user recording a particular data file and later accessing the data file “on demand.” Continuing with the television broadcast illustration discussed above, an example of this paradigm is a user setting up his or her video cassette recorder (VCR) to record a desired television program. Later, when the user wishes to watch the television program “on demand,” the user simply plays the earlier recorded program from his or her VCR. Recently, more advanced digital video recorders have become available, which record the television broadcasts on internal hard drives instead of the video cassette tapes used by traditional VCRs. However, use of the digital video recorders is similar to traditional VCRs in that the users are required to explicitly set the criteria used (e.g. date, time) to determine which broadcasts are recorded on the internal hard drives.

Another limitation with present day broadcast systems is that it is difficult for most users of the client systems to provide feedback to broadcasters with regard to programming. For example, continuing with the television broadcast illustration discussed above, many of today's television broadcasters rely upon Nielson ratings to determine broadcast programming and/or scheduling. Nielson ratings are generally based upon only a small sampling of a cross-section of the public. Consequently, most television viewers have relatively little or no impact on broadcast schedules and/or content.

### BRIEF DESCRIPTION OF THE DRAWINGS

The present invention is illustrated by way of example and not limitation in the accompanying figures.

FIG. 1A is a block diagram illustrating one embodiment of a broadcast system in accordance with the teachings of the present invention.

FIG. 1B is a block diagram illustrating another embodiment of a broadcast system in accordance with the teachings of the present invention.

FIG. 1C is a block diagram illustrating yet another embodiment of a broadcast system in accordance with the teachings of the present invention.

FIG. 2 is a block diagram of one embodiment of a computer system representative of a client or a server in accordance with the teachings of the present invention.

FIG. 3 is a flow diagram illustrating one embodiment of the flow of events in a server and a client with multiple stages of content descriptors and further descriptive content being broadcast to the clients and multiple stages of demand data feedback being sent from the clients to the server in accordance with the teachings of the present invention.

FIGS. 4A through 4C are flow diagrams illustrating various embodiments of content descriptor files being broadcast from a server to clients in accordance with the teachings of the present invention.

FIGS. 5A through 5E are flow diagrams illustrating various embodiments of demand data feedback being sent from a client to a server in accordance with the teachings of the present invention.

FIG. 6 is a flow diagram illustrating an embodiment of the flow of events in a client when processing content descriptors broadcast from a server to maintain a content descriptor table and demand data table in accordance with the teachings of the present invention.

FIG. 7 is an illustration of one example of content descriptors broadcast by a server to describe a in accordance with the teachings of the present invention.

FIG. 8 is an illustration of one example of a content descriptor table updated and maintained by a client in accordance with the teachings of the present invention.

FIG. 9 is an illustration of one example of a demand data table updated and maintained by a client in accordance with the teachings of the present invention.

FIG. 10 is a diagram illustrating one embodiment of data files that are classified by a user in accordance with the teachings of the present invention.

FIG. 11 is a diagram illustrating one embodiment of a content descriptor table that is updated in response to user classifications in accordance with the teachings of the present invention.

FIG. 12 is a diagram illustrating one embodiment of a content descriptor table that is updated after a user access in accordance with the teachings of the present invention.

FIG. 13 is a diagram illustrating one embodiment of a demand data table that is updated after a user access in accordance with the teachings of the present invention.

FIG. 14 is a diagram illustrating another embodiment of a content descriptor table that is updated after another user access in accordance with the teachings of the present invention.

### DETAILED DESCRIPTION

In one aspect of the present invention, methods and apparatuses for determining a content broadcast schedule using a multi-stage broadcast system are disclosed. In another aspect of the present invention, methods and apparatuses are disclosed for sending content descriptors from a server to clients are disclosed. In yet another aspect of the present invention, methods and apparatuses for sending demand data from a client to a server are disclosed. In the following description numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

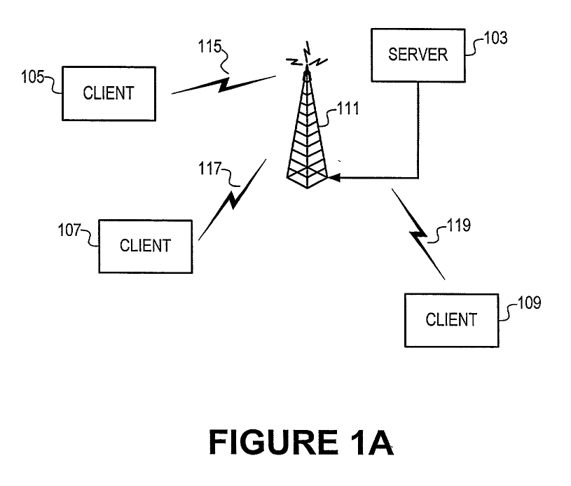

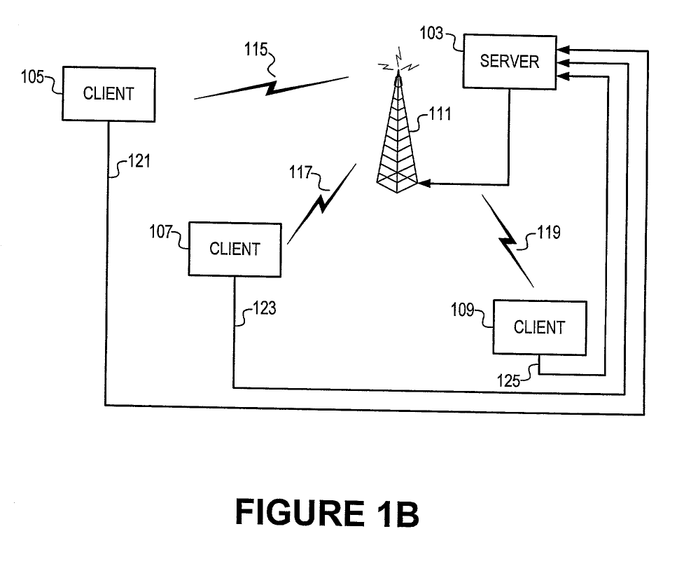

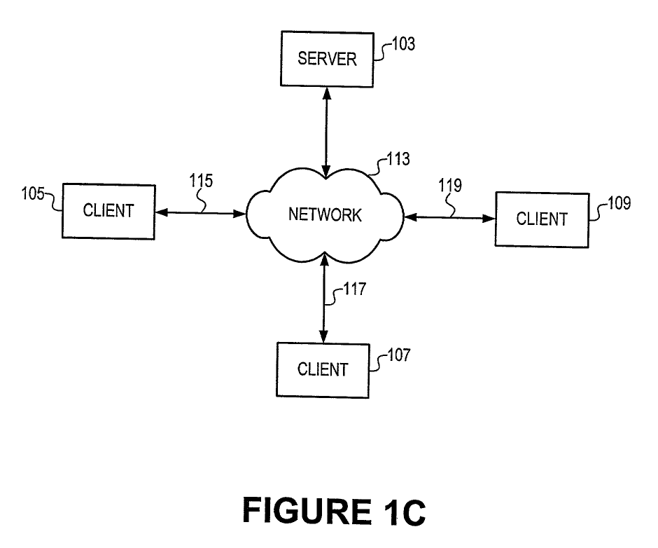

FIG. 1A is an illustration of one embodiment of a broadcast system in accordance with the teachings of the present invention. As illustrated in the depicted embodiment, a broadcast operations center or server 103 is configured to broadcast information to a plurality of clients 105, 107 and 109. In the embodiment shown in FIG. 1A, client 105 receives a broadcast from server 103 through a link 115 from a broadcast antenna 111. Similarly, client 107 receives a broadcast from server 103 through a link 117 and client 109 receives a broadcast from server 103 through a link 119 from broadcast antenna 111. In one embodiment, links 115, 117 and 119 are uni-directional wireless radio frequency (RF) links from broadcast antenna in a format such as for example, but not limited to known amplitude modulation (AM) or frequency modulation (FM) radio signals, television (TV) signals, digital video broadcast (DVB) signals or the like, which are broadcast through the atmosphere.

In one embodiment, server 103 is configured to broadcast a plurality of data files or pieces of content, which may be received by clients 105, 107 and 109. In one embodiment, the data files may be any combination of a number of different types of files including for example video, audio, graphics, text, multi-media or the like. The files may be accessed, streamed or consumed in real-time by the clients 105, 107 or 109 as they are received or the files may be cached or stored for later consumption. For purposes of explanation, many of the examples provided in this disclosure to help describe the present invention assume that the data files to be broadcast by the server are audio/video files, such as for example movies with moving images and sound. However, it will be appreciated that the data files broadcast in accordance with the teachings of the present invention are not limited only to audio/video files.

As illustrated in the embodiment shown FIG. 1A, there is a one-way or unidirectional link between the server 103 and clients 105, 107 and 109. However, in another embodiment, it is appreciated that there may also be a communications link between server 103 and each client 105, 107 and 109, respectively. In particular, FIG. 1B is an illustration of the broadcast system of FIG. 1A with the addition of a “back channel” or communications link between each client 105, 107 and 109 and server 103. In particular, the embodiment illustrated in FIG. 1B shows links 121, 123 and 125, which may be used by clients 105, 107 and 109, respectively, to send information back to server 103. Although links 121, 123 and 125 are illustrated in FIG. 1B as direct links between clients 105, 107 and 109 and server 103, it is appreciated that clients 105, 107 and 109 may communicate information to server 103 through indirect links such as for example but not limited to broadcasted wireless signals, network communications or the like. In one embodiment, it is assumed that links 121, 123 and 125 are lower bandwidth connections than links 115, 117 and 119. For example, that links 121, 123 and 125 could be low bandwidth connections such as modem connections through a public switched telephone network or the like while links 115, 117 and 119 are high bandwidth connections such as television broadcasts, cable television broadcasts, satellite television broadcasts or the like.

FIG. 1C is an illustration of yet another embodiment of a broadcast system in accordance with the teachings of the present invention. As shown, server 103 is coupled to broadcast information to a plurality of clients 105, 107 and 109 through a network 113. In one embodiment, network 113 may be any type of communications network through which a plurality of different devices may communicate such as for example but not limited to the Internet, a wide area network (WAN), a local area network (LAN), an intranet, or the like.

In the embodiment illustrated in FIG. 1C, client 105 is coupled to communicate with broadcast from server 103 through link 115. Similarly, client 107 is coupled to communicate with server 103 through link 117 and client 109 coupled to communicate with server 103 through link 119.

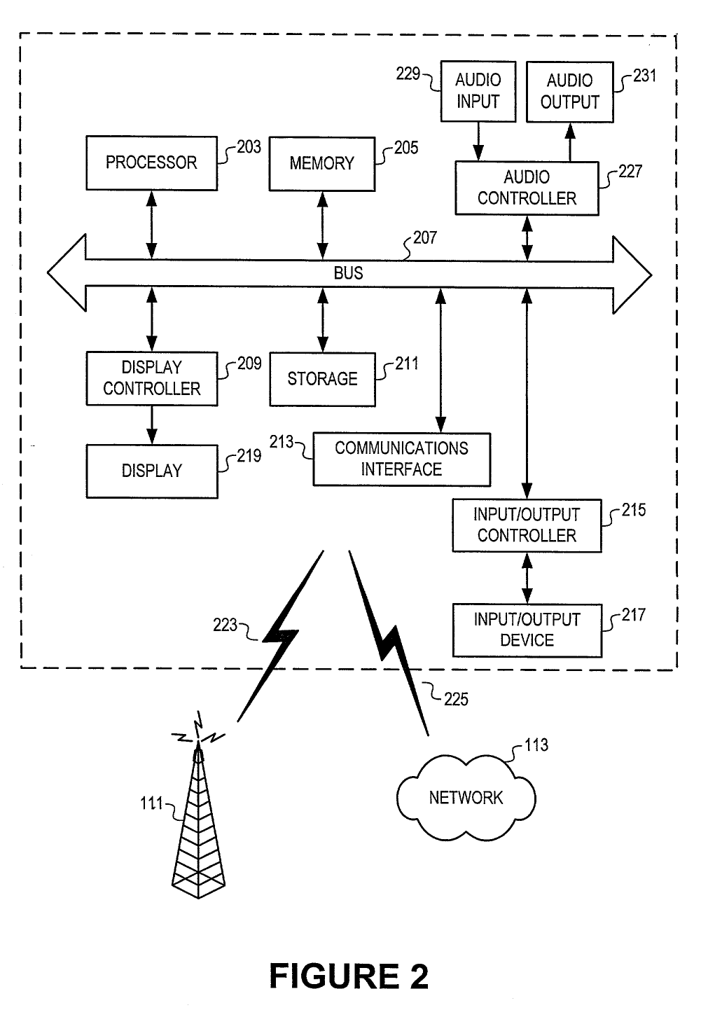

FIG. 2 is a block diagram illustrating one embodiment of a machine 201 that may be used for the server 103, or clients 103, 105 or 107 in accordance with the teachings of the present invention. In one embodiment, machine 201 is a computer or an apparatus that includes a processor 203 coupled to a bus 207. In one embodiment, memory 205, storage 211, display controller 209, communications interface 213, input/output controller 215 and audio controller 227 are also coupled to bus 207.

In one embodiment, machine 201 interfaces to external systems through communications interface 213. Communications interface 213 may include a radio transceiver compatible with AM, FM, TV, digital TV, DVB, wireless telephone signals or the like. Communications interface 213 may also include an analog modem, Integrated Services Digital Network (ISDN) modem, cable modem, Digital Subscriber Line (DSL) modem, a T-1 line interface, a T-3 line interface, an optical carrier interface (e.g. OC-3), token ring interface, satellite transmission interface, a wireless interface or other interfaces for coupling a device to other devices.

In one embodiment, a carrier wave signal 223 is received by communications interface 213 to communicate with antenna 111. In one embodiment, carrier wave signal 225 is received/transmitted between communications interface 213 and network 113. In one embodiment, a communications signal 225 may be used to interface machine 201 with another computer system, a network hub, switch, router or the like. In one embodiment, carrier wave signals 223 and 225 are considered to be machine-readable media, which may be transmitted through wires, cables, optical fibers or through the atmosphere, or the like.

In one embodiment, processor 203 may be a conventional microprocessor, such as for example but not limited to an Intel x86 or Pentium family microprocessor, a Motorola family microprocessor, or the like. Memory 205 may be a machine-readable medium such as dynamic random access memory (DRAM) and may include static random access memory (SRAM). Display controller 209 controls in a conventional manner a display 219, which in one embodiment may be a cathode ray tube (CRT), a liquid crystal display (LCD), an active matrix display, a television monitor or the like. The input/output device 217 coupled to input/output controller 215 may be a keyboard, disk drive, printer, scanner and other input and output devices, including a television remote, mouse, trackball, trackpad, joystick, or the like. In one embodiment, audio controller 227 controls in a conventional manner audio output 231, which may include for example audio speakers, headphones, an audio receiver, amplifier or the like. In one embodiment, controller also controls in a conventional manner audio input 229, which may include for example a microphone or input(s) from an audio or musical device, or the like.

Storage 211 in one embodiment may include machine-readable media such as for example but not limited to a magnetic hard disk, a floppy disk, an optical disk, a smart card or another form of storage for data. In one embodiment, storage 211 may include removable media, read-only media, readable/writable media or the like. Some of the data may be written by a direct memory access process into memory 205 during execution of software in computer system 201. It is appreciated that software may reside in storage 211, memory 205 or may be transmitted or received via modem or communications interface 213.

For the purposes of the specification, the term “machine-readable medium” shall be taken to include any medium that is capable of storing data, information or encoding a sequence of instructions for execution by processor 203 to cause processor 203 to perform the methodologies of the present invention. The term “machine-readable medium” shall be taken to include, but is not limited to solid-state memories, optical and magnetic disks, carrier wave signals, and the like.

In one embodiment, a broadcast system, such as for example one similar to any of those illustrated in FIGS. 1A-1C, is configured to have a server 103 broadcast a plurality of data files to a plurality of clients 105, 107 and 109. As will be discussed in greater detail below, each of the plurality of data files is described with meta-data or content descriptors in accordance with the teachings of one embodiment of the present invention. In general, content descriptors can be considered as a set of descriptors or attribute values that describe pieces of content or data files are available to be broadcast or potentially be broadcast from server 103. The content descriptors of the present invention provide information that enables client systems 105, 107 and 109 to reason and make informed decisions regarding the content of the data files to be broadcast later by server 103. As will be discussed, various embodiments of the present invention utilize the content descriptors for client-side filtering, storage management and other personalization techniques as well as provide demand data feedback determine broadcast schedules and content of future server broadcasts.

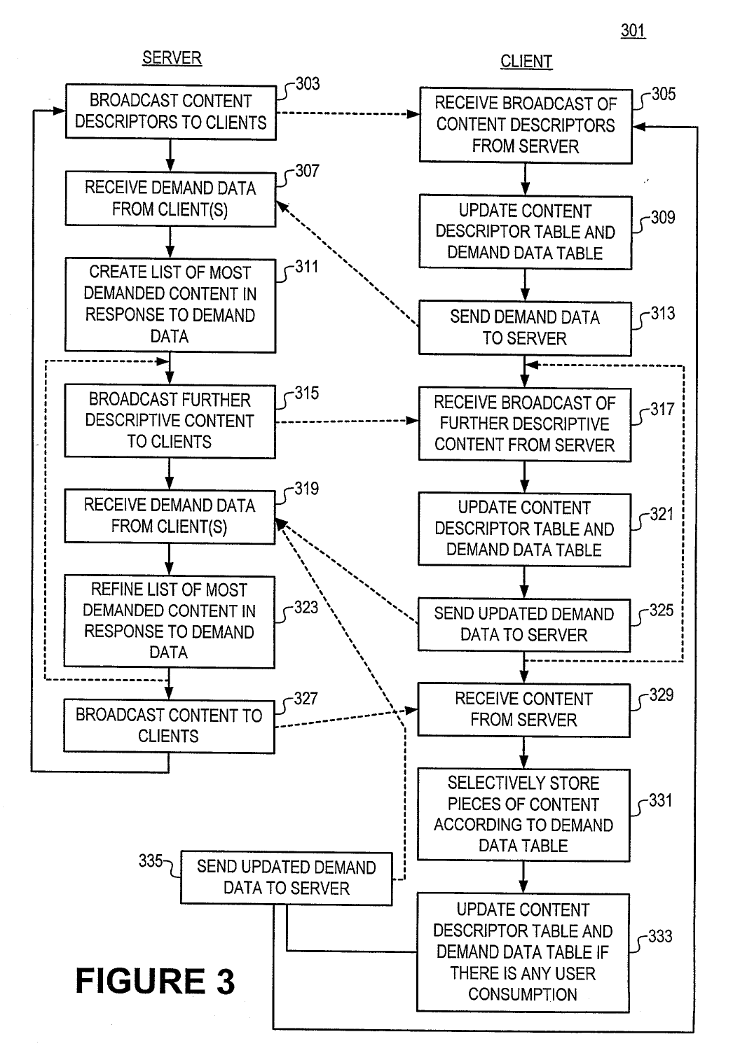

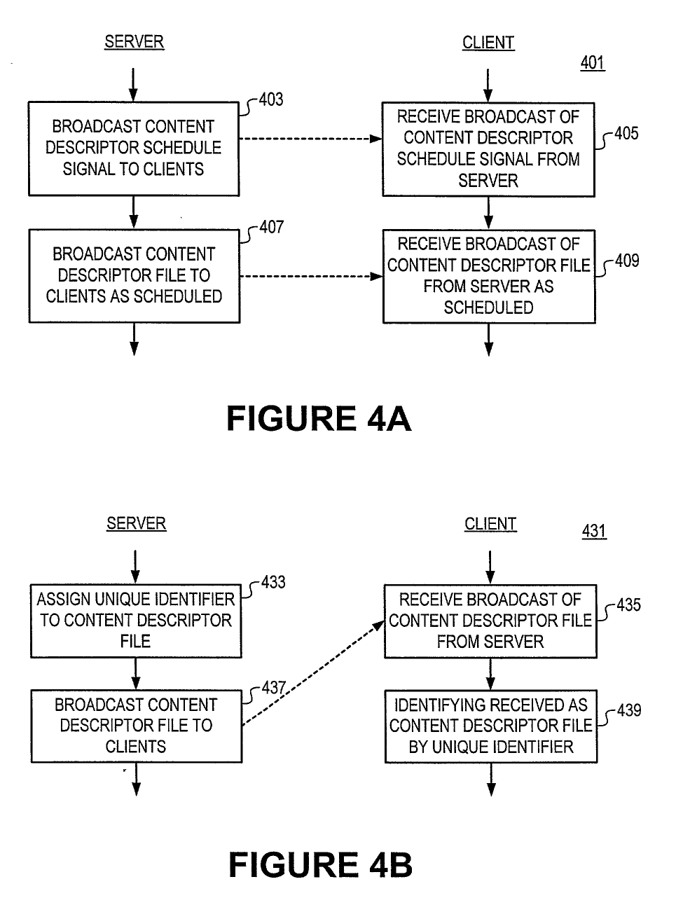

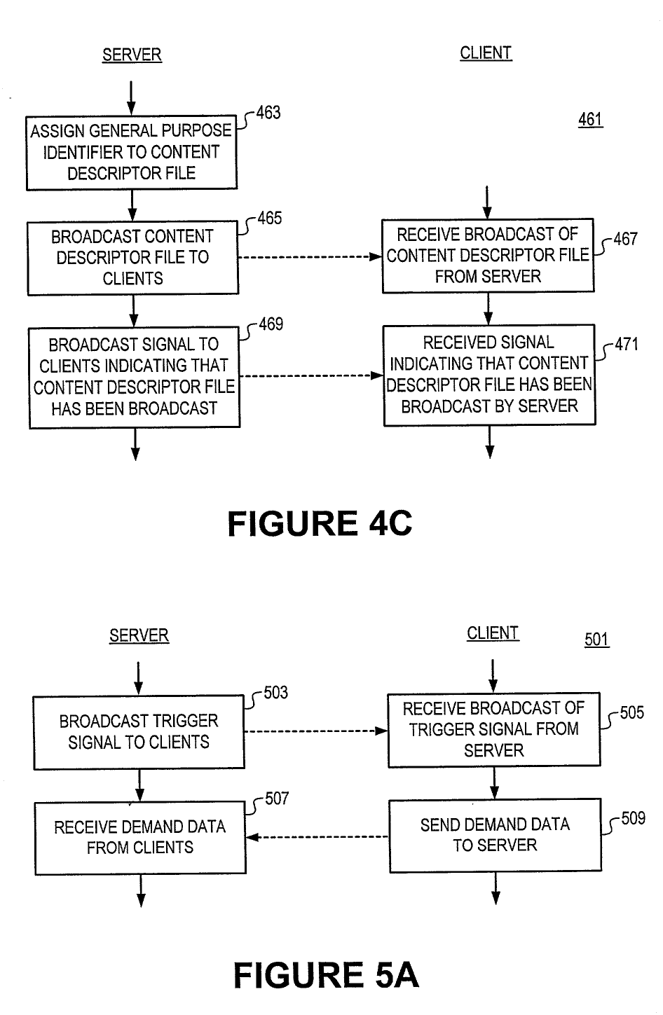

FIG. 3 is a flow diagram 301 illustrating processing that is performed in accordance with teachings of one embodiment of the present invention. In particular, flow diagram 301 illustrates one embodiment of a content distribution system that utilizes a multi-stage process to distribute content from a broadcast operations center or server to one or more clients. As illustrated in processing block 303, the server broadcasts content descriptors to one or more clients. Block 305 illustrates that the content descriptors are received by the one or more clients. In one embodiment, the content descriptors include meta-data or attribute value pairs that are used to describe the available content that may be broadcast potentially by the server. As will be discussed below in connection with FIGS. 4A through 4C, there are a variety of different embodiments in which content descriptor filea may be sent from the server to the clients in accordance with the teachings of the present invention. In one embodiment, the clients may be segregated into specific groups based on geography, network connections or some other criteria.

Block 309 shows that after content descriptors are received, the clients update their content descriptor tables and demand data tables. As will be discussed in detail below, the content descriptor tables and demand data tables are utilized in various embodiments of the present invention by the clients during processing to create demand data. For purposes of this disclosure, “demand data” is an indication by the clients of the desirability of a particular piece of content available from the server. Accordingly, a piece of content that is in high “demand” will have a high degree of desirability and a piece of content that is not in “demand” will have a relatively low degree desirability.

Demand data can be generated in a variety of manners including ranking, rating or the like. For instance, demand data can be determined by generating an ordered list of rankings of at least some of the available content. The ranking establishes a relative order of the available content among content choices. In another embodiment, the demand data can be determined by a generating a list of absolute rating numbers for some or all of the pieces of content. The rating may be accomplished by a user assigning a specific desirability value to each piece of content. The demand data may or may not take into account existing content that is cached on a particular client system. The demand data may be generated by considering explicit user feedback at the client or may be based on previous user behavior or content consumption.

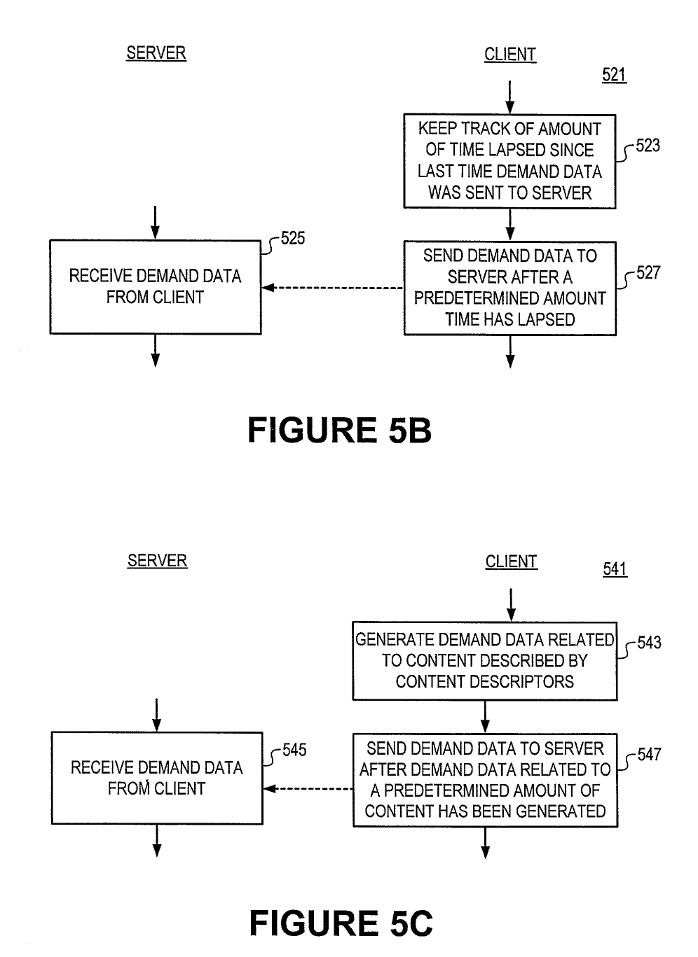

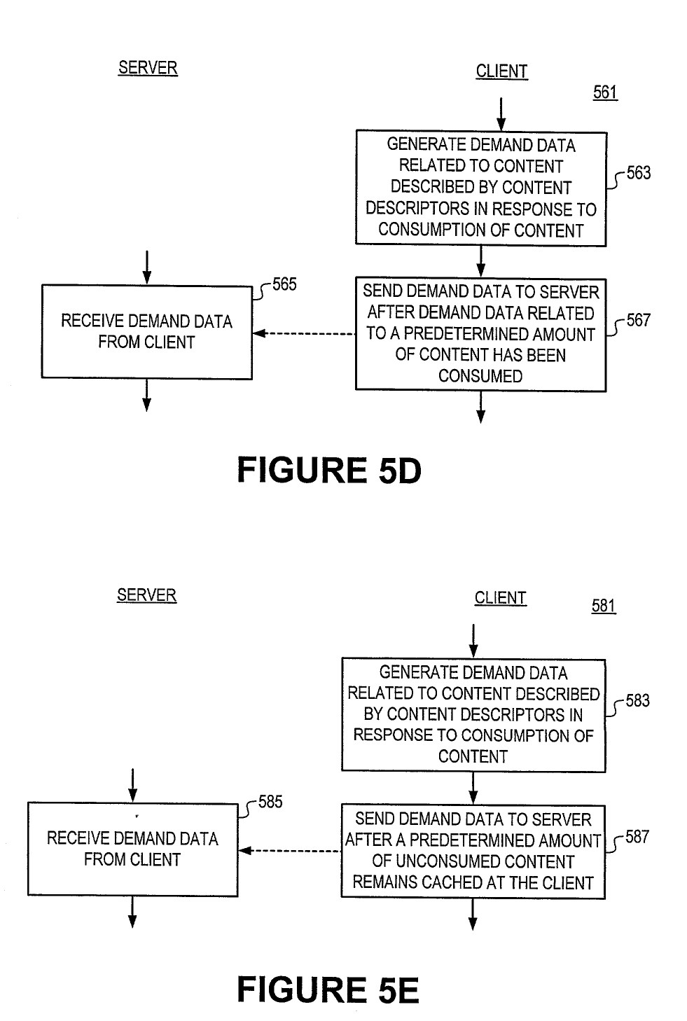

Block 313 shows that demand data feedback is then sent from the client back to the server and block 307 shows that the demand data feedback is received by the server from the client(s). As will be discussed below in connection with FIGS. 5A through 5E, there are a variety of different embodiments in which demand data may be sent from each client to the server in accordance with the teachings of the present invention. For instance, the demand data may be sent in real-time or in batches. The demand data may represent feedback from the users for all available content or only a portion of it. In addition, the feedback may be sent independently by the clients, in response to triggers from the server, or based on some rules.

Block 311 shows that the server then creates a list of the most demanded content in response to the demand data feedback received from the clients. In one embodiment, the list is a sorted list ranging from the higher demanded content down to the lower demanded content based on the demand data feedback received from the clients. In one embodiment, the sorted list is utilized by the server to prioritize the order in which the content is to be broadcast. For instance, in one embodiment, the higher demanded content is broadcast before the lower demanded content is broadcast. In some instances, some of the lower demanded content that is ranked or rated may never be broadcast by the server.

In one embodiment, it is appreciated that this stage of sending content descriptors and receiving demand data feedback from the clients is highly automated and may be transparent to the users. In one embodiment, the ranking or rating systems used to generate the demand data may or may not utilize the same algorithms as those used by the clients to capture and cache the pieces of content when broadcast by the server.

In the next stage, block 315 shows that the server broadcasts further descriptive content to the one or more clients and block 317 shows that the client receives the further descriptive client. In one embodiment, the further descriptive content that is sent is limited to a smaller portion of the available content. The smaller portion of content that is described by the further descriptive content is the content that is determined to be more likely in demand as indicated in the list created in block 311. In one embodiment, the clients filter the further descriptive content sent by the server in block 315. Accordingly, the further descriptive content that is cached by the client describes pieces of content that are more likely to be ranked, rated and/or consumed by the client. In another embodiment, filtering is not performed in block 317.

It is appreciated that in this stage of processing, the server in one embodiment distributes portions of the content in order to receive more user feedback in the form of demand data. In one embodiment, the further descriptive content includes portions of the content and is cheaper to send than the actual content. For example, assuming that the available content includes movies, the further descriptive content may include movie trailers, box art, awards, movie scenes or the like. In the case of music, the further descriptive content may include a song clip, an album preview, historical information about the music artist or the like.

Block 321 shows that the content descriptor table and demand data table are then updated on the client. In one embodiment, the updates to the content descriptor table and demand data table occur in response to explicit user feedback such as rankings or ratings. For example, a user can review the further descriptive content by for example viewing the movie trailers and/or listening to the song clips that the user may potentially be interested in consuming. After reviewing the further descriptive content cached in the user's client system, the user can provide explicit feedback regarding whether the user would be interested in consuming the entire piece of content.

Block 325 shows that updated demand data feedback is then sent from the client back to the server and block 319 shows that the server receives the demand data from the client(s). Block 323 shows that the list of the most demanded content is then further refined in response to the demand data received from the client(s). Accordingly, by receiving feedback from the clients in multiple stages, the server is able to better ascertain the pieces of content that the clients are more likely to consume.

In one embodiment, processing from block 323 loops back to block 315 and processing from block 325 loops back to block 317. In one embodiment, this looping may be repeated a plurality of iterations until the list of most demanded content is refined or narrowed down to a desired degree. As such, an embodiment of the present invention as able to further refine and narrow the list of most demanded content based on explicit feedback. Thus, when the pieces of content are ultimately selected to be broadcast by the server, there is an increased degree of confidence that the clients will consume the content. In one embodiment, explicit user feedback is given more weight that automatically generated feedback without explicit user feedback because explicit user feedback is often more accurate than automated feedback.

In one embodiment, each partial piece of content sent by the server when sending further descriptive content is tracked. In particular, the system maintains and tracks the content pieces such that the final and complete content associated with each partial content is eventually sent in the case that any client requests it. Thus, user expectations are managed as the users become involved in this portion of the ranking or ratings system.

As mentioned above, client systems in one embodiment may apply filters to the further descriptive content received in block 317. Accordingly, the further descriptive content that is cached in the client applies to the pieces of content that the user will more likely desire to consume. As a result, the system is able to send more total further descriptive content in block 315 than an individual client can cache. For example, assume that a client system has a capacity of 5 gigabytes of storage available for further descriptive content sent by the server in block 315. By applying filtering in block 317, the client system will cache 5 gigabytes of for example a total of 20 gigabytes sent by the server. In addition, the 5 gigabytes of further descriptive content that is cached by the client applies to pieces of content that the user is more likely to consume. Furthermore, by applying filtering in block 317, the user will have increased confidence that the cached further descriptive content will describe content in which the user is interested. Since the user will have increased confidence, there may be a higher likelihood that the user will explicitly rank or rate the content to provide the updated demand data in block 325.

In one embodiment, the results of the list created in block 311 in response to the demand data received in block 307 may be stored. In this case, the refined list created in block 323 in response to the demand data received in block 319 are assigned a higher weight since the demand data received in block 307 may have been automatically generated. In another embodiment, the list created in block 311 is not considered once the list refined in block 323 is generated.

In the next stage, block 327 shows that selected pieces of content are then broadcast by the server and block 329 shows that the clients receive the content. In one embodiment, any pieces of content that are described in the further descriptive sent to the clients in block 315 are eventually included in the broadcast of block 327, except for the case where no client explicitly provided positive feedback in the demand data sent to the server in block 325.

As will be discussed in greater detail below, in one embodiment, block 331 shows that the client then selectively stores the pieces of content according to the demand data table maintained by each particular client. In one embodiment, block 333 shows that the content descriptor table and demand data table on each client is then updated if content is consumed. Block 335 shows that the updated demand data is then sent back to the server such that the refined list can be further refined by the server.

As mentioned earlier, there are a variety of different embodiments in which content descriptor file may be sent from the server and received by the clients in blocks 303 and 305 of FIG. 3 in accordance with the teachings of the present invention. For instance, FIG. 4A is a flow diagram 401 showing one embodiment of content descriptors being broadcast from a server to one or more clients. In the illustrated embodiment, block 403 shows that a content descriptor broadcast schedule signal is broadcast from the server and block 405 shows that the client receives the content descriptor broadcast schedule signal.

In one embodiment, the content descriptor broadcast schedule signal is a signal sent to all clients indicating that the content descriptor file will be sent. In one embodiment, the content descriptor broadcast schedule signal includes a description of when the content descriptor file will be sent. For instance, the content descriptor broadcast schedule signal can indicate an absolute time when the content descriptor file will be sent or a relative ordering among other information broadcast by the server. In one embodiment, the content descriptor broadcast schedule signal also indicates to the client how to locate the content descriptor file using for example frequency, Internet protocol (IP) port, IP address information or the like.

In one embodiment, the content descriptor broadcast schedule signal is broadcast using an Internet protocol (IP) signaling protocol, a digital video broadcast signal (DVB), a program and system information protocol (PSIP) signal, or the like. In another embodiment, the content descriptor broadcast schedule signal is embedded within a file broadcast by the server to the clients.

In one embodiment, the client system monitors a broadcast channel for the arrival of the content descriptor broadcast schedule signal. When the content descriptor broadcast schedule signal is received by the client, the client then prepares to receive the content descriptor file when it is scheduled to be broadcast. In one embodiment, the client prepares to receive the content descriptor file by notifying other processes running on the client system that are responsible for processing content descriptors.

In one embodiment, the server then generates or collects the content descriptors into a file. Block 407 shows that the content descriptor file is then broadcast at the appropriate time and then block 409 shows that the content descriptor file is then received as scheduled. In an embodiment in which the content descriptor broadcast schedule signal indicates that the content descriptor file is to be broadcast at an absolute time, the server waits until the designated time and then broadcasts the content descriptor file at that time. In an embodiment in which the content descriptor broadcast schedule signal indicates that the content descriptor file is to be broadcast in a relative order, the server first broadcasts all of the files scheduled to be broadcast prior to the content descriptor file. Then, the server broadcasts the content descriptor file. In one embodiment, the server broadcasts the content descriptor file to the clients using a file transfer protocol such as for example hypertext transfer protocol (HTTP), file transfer protocol (FTP) or the like.

FIG. 4B is a flow diagram 431 showing another embodiment of content descriptors being broadcast from a server to one or more clients. In the illustrated embodiment, block 433 shows that a unique identifier is assigned to the content descriptor file by the server. Block 437 then shows that the content descriptor file is then broadcast to the clients. In one embodiment, the content descriptor file is sent to all clients in a segment. For purposes of this disclosure, a segment can be defined as the plurality of clients or a subset of clients based on geography, network connections, rights vectors or the like.

Block 435 shows that the content descriptor file is then received by the client. Block 439 shows that the client identifies the received file as the content descriptor file based on the unique identifier assigned to the file. In one embodiment, the unique identifier assigned to the content descriptor files causes the client system to store the content descriptor files at a special and/or known location on the client. The client system therefore identifies the incoming file in block 409 as the content descriptor file and processes the file accordingly.

In one embodiment, the client system will allocate a temporary buffer for the content descriptors to be placed in and once the content descriptor file has been completely transferred, the client will lock the previously received content descriptor file and replace its contents with the newly received content descriptor file. In one embodiment, the client system will then signal the process for processing the content descriptors that a new content descriptor file has been received.

FIG. 4C is a flow diagram 461 showing yet another embodiment of content descriptors being broadcast from a server to one or more clients. In the illustrated embodiment, block 463 shows that a general purpose identifier is assigned to the content descriptor file by the server. Block 465 then shows that the content descriptor file is then broadcast by the server. Block 467 shows that the clients receive the content descriptor file. In one embodiment, the content descriptor file broadcast by the server is received by the client as it would receive any other file.

Block 469 shows that the server then broadcasts a signal to the clients indicating that the content descriptor file has been broadcast. Block 471 shows that the clients receive the signal broadcast by the server indicating that the content descriptor file has been broadcast. In one embodiment, this signal also indicates to the clients how to locate the content descriptor file and the signal is broadcast using an Internet protocol (IP) signaling protocol, a digital video broadcast signal (DVB), a program and system information protocol (PSIP) signal, or the like. In another embodiment, the content descriptor broadcast schedule signal is embedded within a file broadcast by the server to the clients. In one embodiment, the client system will then signal the process for processing the content descriptors that a new content descriptor file has been received.

As mentioned earlier, there are a variety of different embodiments in which demand data may be sent from the clients and received by the server in for examples 313, 325 or 335 of FIG. 3 in accordance with the teachings of the present invention. For instance, FIG. 5A is a flow diagram 501 showing one embodiment of demand data being sent from a client to the server in accordance with the teachings of the present invention. Block 503 shows that a trigger signal is broadcast to the clients when the server is ready to receive demand data feedback from the clients. In one embodiment, the server may broadcast the trigger signal because the server is ready to construct another list or schedule of content to be broadcast to the clients. Block 505 shows that the client receives the trigger signal broadcast by the server. In one embodiment, the trigger signal can request demand data feedback from all of the clients or from a set of clients in for example a segment. In response, block 509 shows that the client sends the demand data to the server and block 507 shows that the server receives the demand data feedback.

In one embodiment, the clients send the demand data to the server by initiating a connection to the server to provide the demand data feedback to the server. In the case where a client is unable to establish a connection for reasons including for example a busy telephone signal or the like, the client in one embodiment utilizes a binary exponential back-off system. Accordingly, the server is provided regular connections to the plurality of clients attempting to provide demand data feedback.

FIG. 5B is a flow diagram 521 illustrating another embodiment of demand data being sent from a client to the server in accordance with the teachings of the present invention. In the embodiment illustrated in flow diagram 521, the clients provide demand data feedback to the server at different times. This embodiment may be utilized in situations where it is not practical for the server to receive demand data feedback from all of the clients simultaneously due to for example bandwidth or network load limitations. For instance, if a public switched telephone network (PSTN) is used for a back channel, it may be unrealistic or impractical for all clients to dial up the server simultaneously after receiving the trigger signal.

Block 523 shows that the client system keeps track of the amount of time that has lapsed since the last time demand data was sent back to the server. In one embodiment, block 523 is accomplished by the client by maintaining a timer representing the amount of time since the client last provided demand data feedback to the server. In one embodiment, after a predetermined amount of time has lapsed, block 527 shows that the client sends the demand data back to the server and block 525 shows that the server receives the demand data. In one embodiment, the client system sends the demand data by establishing the connection to the server.

FIG. 5C is a flow diagram 541 illustrating yet another embodiment of demand data being sent from a client to the server in accordance with the teachings of the present invention. In the embodiment illustrated in flow diagram 541, the clients are assumed to generate demand data feedback at different rates. As a result, some clients will have more demand data feedback than others over a given time period. Consequently, clients provide the feedback based on the amount of content that has been ranked or rated.

To illustrate, block 543 shows that the client system generates demand data related to content described by the content descriptors. The demand data may be generated automatically or manually. In one embodiment, the client maintains a count of the number of pieces of content that have been rated since that last time demand data feedback was sent to the server. Block 547 shows that after demand data related to a predetermined amount of pieces of content have been generated, the demand data is sent to the server. In one embodiment, the predetermined amount of pieces of content that is used as a threshold to determine when to send the demand data feedback is fine tuned to each client system to consider the rate at which content is broadcast, the rate at which content descriptors are broadcast and bandwidth capacity of the communications link from the client to the server. Block 545 shows that the demand data is received by the server. In one embodiment, the client system sends the demand data by initiating the connection to the server.

FIG. 5D is a flow diagram 561 illustrating still another embodiment of demand data being sent from a client to the server in accordance with the teachings of the present invention. In the embodiment illustrated in flow diagram 561, the clients are assumed to consume content at different rates. As a result, some clients will have consumed more content than other clients in a given amount of time. Thus, clients provide feedback based on the amount of content consumed.

To illustrate, block 563 shows that the client system generates demand data related to content consumed by the user. In one embodiment, the client maintains a count of the number of pieces of content that have been consumed since that last time demand data feedback was sent to the server. Block 567 shows that after a predetermined amount of pieces of content have been consumed, the demand data is sent to the server. Block 565 shows that the demand data is received by the server. In one embodiment, the client system sends the demand data by initiating the connection to the server.

FIG. 5E is a flow diagram 581 illustrating yet another embodiment of demand data being sent from a client to the server in accordance with the teachings of the present invention. In the embodiment illustrated in flow diagram 581, the clients are assumed to consume content at different rates, as in the embodiment illustrated in flow diagram 561. As a result, some clients will use up the available unconsumed content cached in their client systems faster than other clients in a given amount of time. Thus, clients provide feedback based on the amount of unconsumed content remaining cached in their client systems.

To illustrate, block 583 shows that the client system generates demand data related to content consumed by the user. In one embodiment, the client maintains a count of the number of unconsumed pieces of content that remain stored in the client system. Block 587 shows that when less than a predetermined amount of pieces of content remain cached at the client, the demand data is sent to the server. Thus, when the client ultimately receives more content broadcast by the server to refill the cache, the server will have had an opportunity to consider the demand data generated by the client previously. As a result, the client cache is more likely to be refilled with content that is more desirable to the client. Block 585 shows that the demand data is received by the server. In one embodiment, the client system sends the demand data by initiating the connection to the server.

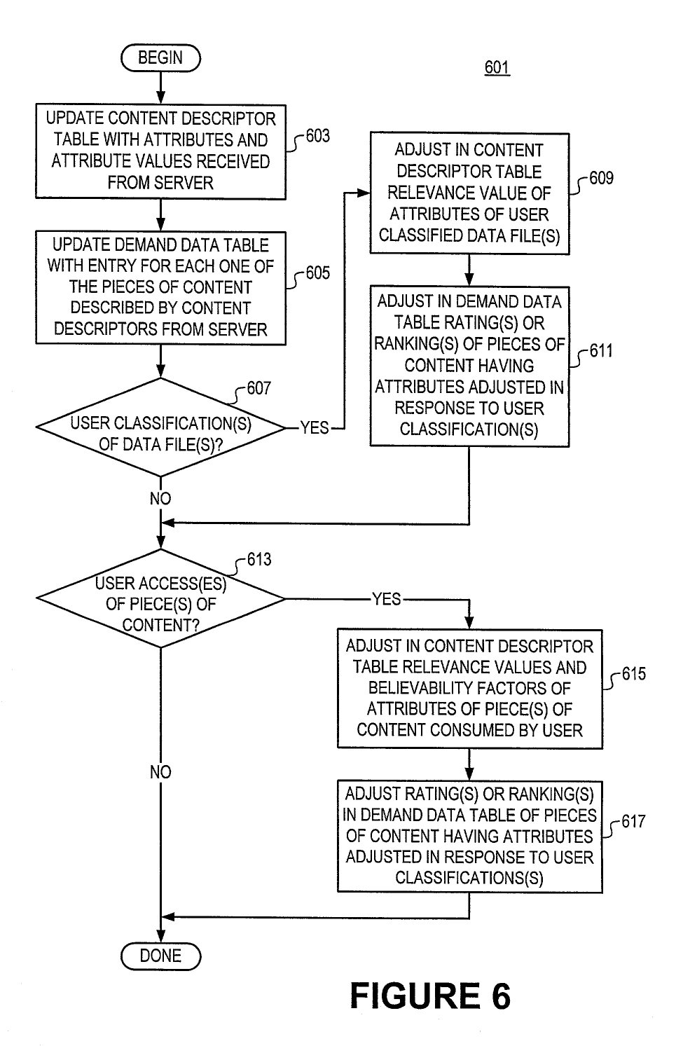

FIG. 6 is a flow diagram 601 illustrating one embodiment of the flow of events in a client when processing content descriptors broadcasted from a server and updating and maintaining a content descriptor table and a demand data table in accordance with the teachings of the present invention. In particular, process block 603 shows that a content descriptor table is updated with attributes and attribute values included in the content descriptors broadcasted from the server. Process block 605 shows that the demand data table is then updated with an entry for each one of the data files described by the content descriptors broadcast from the server.

In one embodiment, it is assumed that a content descriptor table, a demand data table and a plurality of data files already exist in the client system. In one embodiment, the content descriptor table, demand data table and plurality of data files may be stored and maintained in the client system in memory 205, storage 211 or by accessing a local network or the like with machine 201, as illustrated in the embodiment shown in FIG. 2.

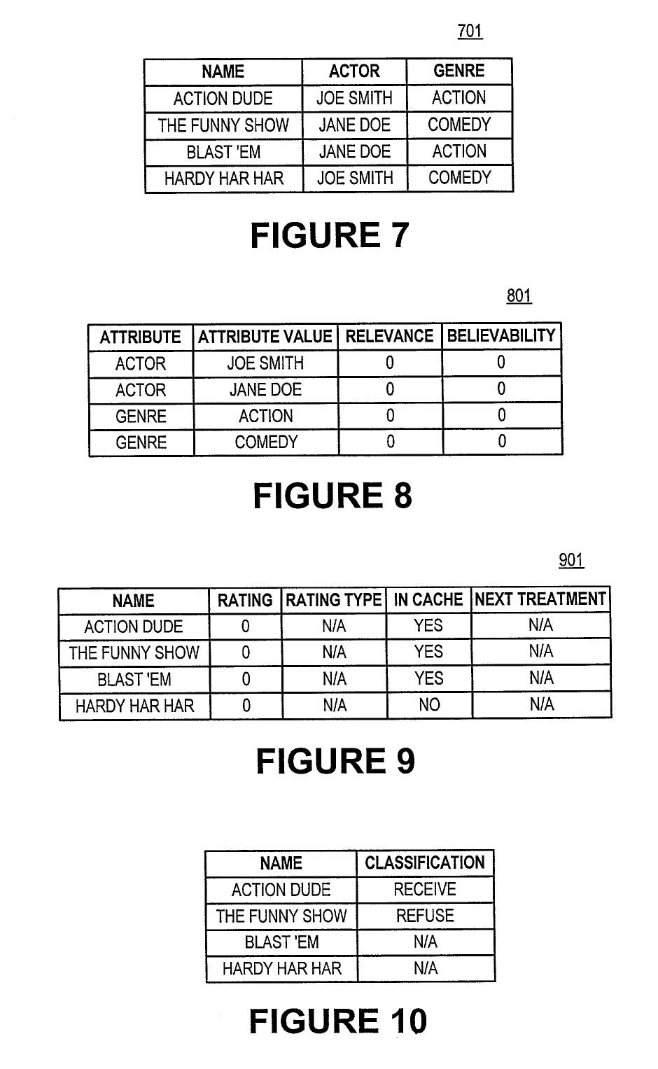

To help illustrate the content descriptors aspect of the present invention, FIG. 7 is an example of one embodiment of content descriptors 701, which may be broadcast by the server 103 to the clients 105, 107 and 109. For explanation purposes, it is assumed that the data files broadcast by server 103 in this example are audio/video files such as for example movies or TV programming. As mentioned above, data files may be other types of files such as for example but not limited to audio, graphics, text, multi-media or the like.

In the illustrated embodiment, content descriptors 701 in FIG. 7 shows that four movies, or data files, will be broadcast later by server 103. These movies shown in this example are “Action Dude,” “The Funny Show,” “Blast 'Em” and “Hardy Har Har.” Content descriptors 701 include attributes and attribute values that describe each one of the movies to be broadcast later by server 103. In the example illustrated, two attributes are provided to describe each movie in content descriptors 701. The attributes shown in FIG. 7 are “Actor” and “Genre.” It is appreciated that other embodiments of the present invention may include different attributes as well as other attributes values. For instance, a non-exhaustive list of other attributes that may be used to describe movies may include “Director,” “Year,” “Effects,” “Ending,” etc. In one embodiment, for example, 40-50 different attributes are provided to describe movies in accordance with the teachings of the present invention.

Referring back to the particular example shown in FIG. 7, “Action Dude” is an “action” movie featuring actor “Joe Smith.” “The Funny Show” is “comedy” movie featuring actress “Jane Doe.” “Blast 'Em” is an “action” movie featuring actor “Jane Doe.” “Hardy Har Har” is a “comedy” movie featuring “Joe Smith.”

To help illustrate the content descriptor table aspect of the present invention, FIG. 8 is an example of one embodiment of content descriptor table 801, which is updated and maintained locally by each client 105, 107 and 109. In the illustrated embodiment, content descriptor table 801 in FIG. 8 has been populated with the data included in content descriptors 701, which was broadcasted earlier from server 103. In one embodiment, content descriptor table 801 includes a list of attributes, attribute values and corresponding relevance values and believability factors. In particular, content descriptor table 801 includes attribute values “Joe Smith,” “Jane Doe,” “action,” and “comedy.” At this time, the relevance values and believability factors for attribute values “Joe Smith,” “Jane Doe,” “action,” and “comedy” are all zero in FIG. 8. As will be shown, in one embodiment, the relevance values and believability factors of the present invention will be updated and maintained as the user interacts with the client system.

In one embodiment, the relevance values in content descriptor table 801 are indicators as to how relevant the associated attribute and attribute values are for predicting a particular user's behavior. For instance, the relevance value indicates how likely it is for the user to watch a particular movie because of this particular attribute value. In one embodiment, relevance values in content descriptor table 801 are within a range of values such as for example from −10 to 10. As will be discussed, the relevance value may be increased if for example the user watches a particular movie or at least expresses an interest in a particular movie having that particular attribute value. Conversely, the relevance value may be decreased if the user for example does not watch a particular movie or if the user explicitly indicates that he or she does not want to watch a particular movie having that particular attribute value.

In one embodiment, the believability factors in content descriptor table 801 are weighting factors to be applied to specific attribute and attribute value pairs when rating or predicting whether a user will actually access a particular data file having that particular attribute value. In one embodiment, believability factors in content descriptor table 801 are within a range of values such as for example from −10 to 10. In one embodiment, the believability factors may be increased for example when an attribute value accurately predicts a data file in which the user is interested. Conversely, the believability factors may be decreased when a user is interested in the data file, even though the particular attribute value indicates otherwise.

In one embodiment, content descriptor table 801 entries are constructed from the aggregation of all content descriptors 701 associated with potential content or data files to be broadcast from server 103. In one embodiment, entries in content descriptor table 801 are updated based on explicit user requests. In addition, updates to content descriptor table 801 may also be implicitly based on whether a user accesses specific data files having particular attribute values, independent of whether the user explicitly classifies a particular movie.

To help illustrate the demand data table aspect of the present invention, FIG. 9 is an example of one embodiment of a demand data table 901, which in one embodiment is updated and maintained locally by each client 105, 107 and 109. In the illustrated embodiment, demand data table 901 in FIG. 9 includes a list of the data files described in content descriptors 701 as well as any additional data files that are currently stored or cached locally by the client.

In one embodiment, data files may be stored locally by the client in for example memory 205, storage 211 or in a locally accessible network by machine 201 of FIG. 2. For purposes of this disclosure, data files being stored locally by the client may also be interpreted to include a data file stored “locally” by the client in a known network storage configuration, separate from the server. For purposes of this disclosure, the data file being stored or cached locally by the client is to be interpreted as the data file being stored for later access, retrieval or consumption. In one embodiment, the local cache of the present invention is considered to be a first level cache. Thus, the local cache of the present invention is sized accordingly to increase the possibility of a single hit.

Referring back to the continuing example of data files representing audio/video files, a movie is stored locally by the client. After a user watches the movie, the storage space occupied by the movie is generally considered to be available for storage of another movie to be broadcast sometime later. Thus, it is appreciated that the local cache of the client system is modeled as the single use system, e.g. fire and forget, in accordance with teachings of the present invention. In one embodiment, it is assumed that when a user accesses a data file, it is not likely that the user will want to access that same data file again. If a user has not watched a particular movie, the storage space occupied by that movie is generally considered not to be available for storage of another movie. However, if there is no additional storage space available and a higher rated movie is to be broadcast, the lower rated unwatched movie is replaced by the higher rated movie in accordance with the teachings of the present invention.

Referring back to the embodiment of demand data table 901 shown in FIG. 9, each movie also has an associated rating, a rating type indicator, an in cache indicator and a next treatment indicator. In one embodiment, the rating indicates a rating value for the associated data file. The rating value in one embodiment may either be explicitly input by a user or implicitly generated by the client system by processing content descriptors associated with that particular data file. In one embodiment, a relatively high rating value predicts that the particular data file may be of interest to the user. Conversely, in one embodiment, a relatively low rating value predicts that the particular data file is unlikely to be of interest to the user.

In one embodiment, the rating type indicator indicates whether the rating value of this particular data file was a result of explicit input from the user or if the rating value was implicitly generated by the client system. Thus, in one embodiment, the rating type indicator of demand data table 901 may be explicit, implicit or N/A if the data file or movie has not yet been rated. In one embodiment, if a data file has been explicitly classified by a user, the rating values of attribute values of the data file are no longer updated implicitly by the client system. However, if a data file has not yet been classified or has only been implicitly rated by the client system, the rating of the attribute values of the data file may be further updated or adjusted by the client system.

In one embodiment, the in cache indicator indicates whether that particular data file is currently stored or cached locally by the client. In the embodiment illustrated in FIG. 9, the movies “Action Dude,” “The Funny Show” and “Blast 'Em” already exist in the local storage of the client system. Conversely, the movie “Hardy Har Har” has not been stored in the local storage of the client system in the example illustrated in FIG. 9.

In one embodiment, the next treatment indicator is used to track future actions to be taken for the particular data file. For example, if a movie has already been watched by the user, the next treatment indicator would indicate “replace” to indicate that the storage space occupied by that particular movie is available for storage of another movie. In one embodiment, if the movie has not yet been watched by the user, the next treatment indicator would indicate “keep.” In one embodiment, if the movie has not been stored locally by the client and if the rating value predicts that this particular movie may be of interest to the user, the next treatment indicator would indicate “capture.” In one embodiment, if the movie has not yet been broadcast by the server and the rating predicts that this movie is unlikely to be of interest to the user, the next treatment indicator would indicate “ignore.”

As was discussed back to FIG. 6, process blocks 603 and 605 show that the content descriptor table and the demand data table are updated according to content descriptors broadcast from the server. Decision block 607 shows that it is then determined whether there is a user classification of any of the data files. Referring briefly to FIG. 10, an example is shown where a user classifies some of the movies, as described by content descriptors 701. In particular, the user has expressed interest in the movie “Action Dude” by indicating that he or she wishes to receive that movie. In this example, the user has expressed that he or she does not have any interest in the movie “The Funny Show” by indicating that he or she refuses that movie. In this example, the user has not provided any information or classification regarding any of the remaining movies.

Referring back to FIG. 6, if the user has classified any of the data files, process block 609 shows that the relevance values of the particular attributes of the classified data files are updated in content descriptor table 801. Process block 611 shows that the ratings of data files having attribute values with relevance values that were adjusted in response to the user classification(s) are also adjusted. In one embodiment, if the user has not classified any data files, process blocks 609 and 611 are skipped.

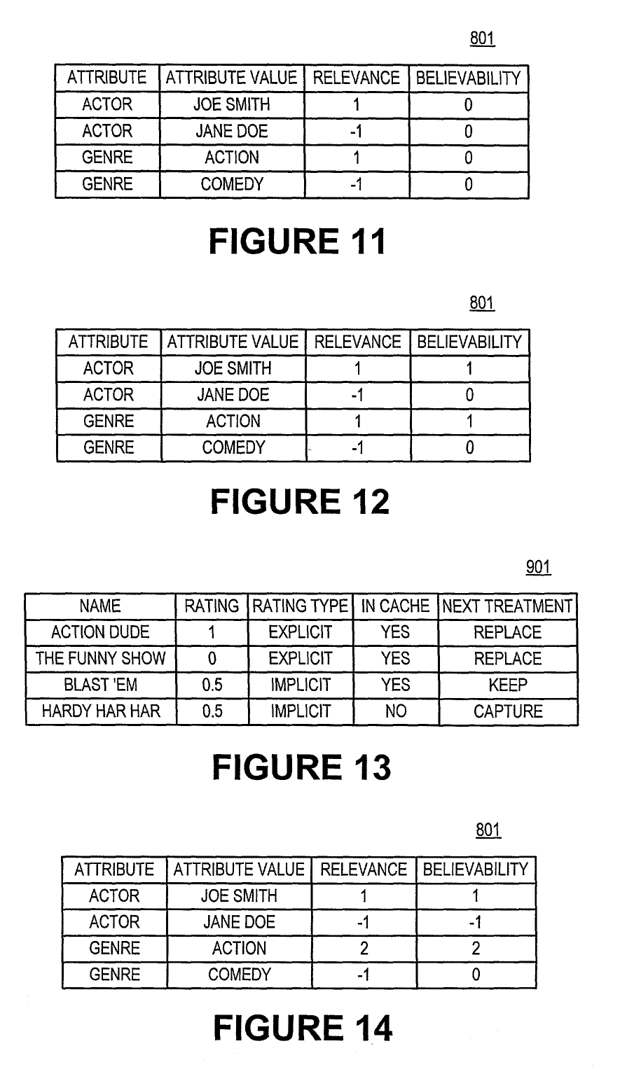

To illustrate an example of when a user classifies data files, FIG. 11 shows a content descriptor table 801 that is updated or adjusted in response to a user classification. In the example provided in FIG. 10, the user indicated that he or she was interested in the movie “Action Dude.” Content descriptors 701 in FIG. 7 shows that “Action Dude” features actor “Joe Smith” and is an “action” movie. Thus, referring to content descriptor table 801 in FIG. 11, the relevance values for attribute values “Joe Smith” and “action” are adjusted to reflect that the user explicitly expressed an interest in “Action Dude.” In one embodiment, the relevance values are increased to reflect that the user was interested. As will be discussed, in one embodiment, the believability factors associated with each attribute value are not updated until there is a user access of the data file having that particular attribute value.

Continuing with the example of FIG. 10, the user indicated that he or she was not interested in the movie “The Furmy Show.” Content descriptors 701 in FIG. 7 shows that “The Funny Show” features actress “Jane Doe” and is a “comedy” movie. Thus, referring back to content descriptor table 801 in FIG. 11, the relevance values for attribute values “Jane Doe” and “comedy” are adjusted to reflect that the user explicitly expressed that he or she was not interested in “The Funny Show.” In one embodiment, the relevance values are decremented to reflect that the user was not interested.

Continuing with the example of FIG. 10, the user did not provide any information regarding the movies “Blast 'Em” and “Hardy Har Har.” Accordingly, the relevance values of the attribute values associated with “Blast 'Em” and “Hardy Har Har” are not updated in content descriptor table 801.

As will be discussed, in one embodiment, updates to the ratings in demand data table 901, as described in process block 611, are related to the relevance values and believability factors of the attribute values listed in content descriptor table 801. A detailed description of the processing that occurs in process block 611 will be discussed below with a discussion of process block 617.

Referring back to FIG. 6, if the user accesses any of the data files, e.g. the user watches a movie, as determined in decision block 613, process block 615 shows that the relevance values and the believability factors of the particular attributes of the user accessed data files are updated in content descriptor table 801. Process block 617 shows that the ratings of data files having attribute values with relevance values that were adjusted in response to the user access(es) are also adjusted. If the user has not accessed any data files, process blocks 615 and 617 are skipped.

To illustrate an example of a user accessing data files, assume that the user watches the movie “Action Dude.” Content descriptors 701 in FIG. 7 shows that “Action Dude” features actor “Joe Smith” and is an “action” movie. In one embodiment, each time a user accesses or interacts with particular data file, the believability factor of the attribute values of that film are adjusted or updated. In one embodiment, for attribute values having relevance values greater than zero, the believability factor for that attribute value is increased, since that attribute value accurately served as a predictor for a data file that the user would access. In one embodiment, for attribute values having relevance values less than zero, the believability factor for that attribute value is decreased, since that attribute value did not accurately serve as a predictor for a data file that the user would access. Therefore, FIG. 12 shows a content descriptor table 801 that is updated or adjusted in response to the user access of “Action Dude.” In this example, the believability factors of “Joe Smith” and “action” are increased since the relevance values for these attribute values were greater than zero.

In one embodiment, the relevance values associated with implicitly rated data files are also increased in content descriptor table 801 in response to a user access. However, in the example shown in content descriptor table 801 of FIG. 12, “Action Dude” was explicitly classified by the user. In one embodiment, the relevance values are not updated in content descriptor table 801 in response to a user access of data files explicitly classified by the user.

FIG. 13 shows demand data table 901, which is updated in response to the user access of “Action Dude,” as described in process block 617. As mentioned earlier, demand data table 901 is also updated as described in process block 611 in accordance with the teachings of the present invention. As shown in demand data table 901 of FIG. 13, “Action Dude” has a rating value of 1. The rating type of “Action Dude” is “explicit” because the user explicitly classified “Action Dude,” as described above in connection with FIG. 10. The in cache indicator indicates that “Action Dude” is presently locally stored by the client system. The next treatment indicator indicates replace because the user has already watched “Action Dude.”

In one embodiment, the rating values in demand data table 901 are determined as follows. Content descriptors 701 shows that “Action Dude” has the attribute values “Joe Smith” and “action.” Content descriptor table 801 of FIG. 12 shows that “Joe Smith” has a relevance value of 1 and a believability factor of 1. Content descriptor table 801 of FIG. 12 also shows that “action” has a relevance value of 1 and a believability factor of 1. In one embodiment, the rating value of a particular data file is determined considering all of the relevance values combined with their respective believability factors for all the attribute values of the data file. For instance, in one embodiment, the rating value for a data file is equal to the average of all of products of each relevance value and corresponding believability factor for the attribute values of the data file.

To illustrate, referring to “Action Dude” in demand data table 901 of FIG. 13, the product of the relevance value and believability factor of “Joe Smith” is 1 * 1, which equals 1. The product of the relevance value and believability factor of “action” is 1 * 1, which equals 1. The average of the products, 1 and 1, is 1. Therefore, the rating of “Action Dude” in demand data table 901 of FIG. 13 is 1.

Similarly, with regard to “Blast 'Em” in demand data table 901, “Blast 'Em” has the attribute values “Jane Doe” and “action.” The relevance value and believability factors for “Jane Doe” in content descriptor table 801 of FIG. 12 are −1 and 0, respectively. Thus, the rating of “Blast 'Em” in demand data table 901 is the average of 1 * 0 and 1 * 1, which equals 0.5. The ratings for “The Funny Show” and “Hardy Har Har” in demand data table 901 in the example shown in FIG. 13 are determined in a similar fashion in one embodiment of the present invention.

It is noted that since the user classified the movies “Action Dude” and “The Funny Show” above in FIG. 10, these movies have an explicit rating type as shown in demand data table 901 of FIG. 13. Since the user did not classify the movies “Blast 'Em” and “Hardy Har Har,” these movies have an implicit rating in demand data table 901.

It is appreciated that the discussion above provides one example of how the rating values in demand data table 901 are determined in accordance with the teachings of the present invention. It is noted that ratings values may be determined in other ways in accordance with the teachings of the invention, which consider the relevance values and believability factors for each of the attribute values of a data file.

In one embodiment, the entry for next treatment in demand data table 901 is determined in part by the rating and in cache values for the particular data file. For example, assume in one embodiment that a rating of greater than zero indicates that the user is predicted to have at least some interest in that particular movie. Therefore, the movies “Blast 'Em” and “Hardy Har Har” may be of some interest to the user. Thus, the next treatment indicates that the movie “Blast 'Em” will be kept in storage and the movie “Hardy Har Har” will be captured when it is later broadcast by the server. As mentioned above, the movie “Action Dude” is marked for replacement in the next treatment field because it has already been watched by the user.

In one embodiment, future interactions by a user with the client system results in similar processing as described above. For instance, assume that the user now watches the movie “Blast “Em.” In this particular example, the user did not classify the movie “Blast 'Em” before watching the movie. In one embodiment, both of the relevance values and believability factors are updated for the attribute values of unclassified data files that are accessed, as shown in content descriptor table 801 of FIG. 14. Recall from FIG. 7 that the movie “Blast 'Em” features “Jane Doe” and is an “action” movie. As shown in FIG. 12, the relevance value of “Jane Doe” was less than zero, or −1, prior to the user watching “Blast 'Em.” Nevertheless, in this example, the user watched “Blast 'Em,” despite the fact that it featured actress “Jane Doe.” Accordingly, the believability factor of the “Jane Doe” attribute the value is adjusted downward since this particular attribute value now appears less likely or relevant when predicting a user's viewing habits. In one embodiment, since the relevance value is already less than zero, the believability factor is not adjusted further downward. However, the relevance value and believability factor for the attribute value “action” are adjusted upwards since “action” had a relevance value of greater than zero prior to the user watching “Blast 'Em.” Thus, in this example, the relevance value is adjusted upwards from 1 to 2 and the believability factor is also adjusted upwards from 1 to 2. Therefore, the demand data table 801 of FIG. 14 now predicts that “action” movies are movies that the user is more likely to watch.

In one embodiment, each time the user interacts with the client system, the content descriptor table 801 and the demand data table 901 are updated. Updates to content descriptor table 801 and demand data table 901 are performed when the user accesses data files as well as when the user explicitly classifies data files. It is appreciated that the user is not required to classify data files explicitly in order for the content descriptor table 801 and demand data table 901 to be updated in accordance with the teachings of the present invention. As a result, the demand data table over time will more accurately predict data files in which the user is interested.

In one embodiment, the data files in which the user is predicted implicitly to be most interested as well as the data files in which the user explicitly classified an interest will be the data files that are cached locally on the client system. In effect, the movies that the user is most likely to want to watch are automatically stored locally, and therefore available “on demand,” in accordance with teachings of the present invention without the user having to explicitly request these movies in advance or explicitly specify criteria used to identify the movies.

As can be appreciated, by storing the data files locally on each client, broadcast bandwidth is utilized more efficiently in accordance with teachings of the present invention. Indeed, when a user watches a movie from the local storage of the client, no additional broadcast bandwidth is utilized. In addition, it is also appreciated that a substantial amount of the processing performed in a system according to the teachings of the present invention is performed on each of the client systems when updating their respective content descriptor tables and demand data tables. This distributed processing of the present invention enables the presently disclosed broadcast system to scale across a very large number of users since the incremental cost to the server for each additional client is zero.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

[image]

[image]

What is claimed is:

1. A method, comprising:
broadcasting a content descriptor schedule signal to one or more clients to indicate that a content descriptor file is to be broadcast to said one or more clients at a broadcast time;
broadcasting the content descriptor file to said one or more clients at the broadcast time.

2. The method of claim 1 wherein the content descriptor schedule signal is embedded within a file that is broadcast.

3. The method of claim 1 further comprising generating the content descriptor file prior to broadcasting the content descriptor file.

4. A method, comprising:
receiving a content descriptor schedule signal broadcast by a server, the content descriptor schedule signal to indicate that a content descriptor file is to be broadcast at a broadcast time;
receiving the content descriptor file at the broadcast time;
processing the content descriptor file to generate demand data feedback to be provided to the server.

5. The method of claim 4 further comprising notifying a process in a client system to process the content descriptor file in response to receiving the content descriptor file.

6. The method of claim 4 wherein receiving the content descriptor file at the broadcast time comprising receiving the content descriptor schedule signal using a signaling protocol including one of internet protocol (IP), digital video broadcast signal (DVB) or program and system information protocol (PSIP).

7. The method of claim 4 wherein the generation of the demand data feedback comprises the generation of ranking feedback.

8. The method of claim 4 wherein the generation of the demand data feedback comprises the generation of rating feedback.

9. A method, comprising:
broadcasting a content descriptor schedule signal to one or more clients to indicate that a content descriptor file is to be broadcast to said one or more clients after a first file is broadcast;
broadcasting the first file to said one or more clients; and
broadcasting the content descriptor file to said one or more clients after the first file is broadcast to said one or more clients.

10. The method of claim 9 wherein broadcasting a content descriptor schedule signal comprises broadcasting the content descriptor schedule signal using a signaling protocol including one of internet protocol (IP), digital video broadcast signal (DVB) or program and system information protocol (PSIP).

11. The method of claim 9 wherein broadcasting a content descriptor schedule signal comprises broadcasting the content descriptor schedule signal in a file.

12. A method, comprising:
receiving a content descriptor schedule signal broadcast by a server, the content descriptor schedule signal to indicate that a content descriptor file is to be broadcast after a first file is broadcast;
receiving the first file broadcast by the server; and
receiving the content descriptor file broadcast by the server after the broadcast of the first file;
processing the content descriptor file to generate demand data feedback to be provided to the server.

13. The method of claim 12 wherein the content descriptor schedule signal further includes information indicating how to locate the content descriptor file.

14. The method of claim 13 wherein the information indicating how to locate the content descriptor file includes one of a frequency, an internet protocol (IP) port or an IP address.

15. The method of claim 12 wherein the generation of the demand data feedback comprises the generation of ranking feedback.

16. The method of claim 12 wherein the generation of the demand data feedback comprises the generation of rating feedback.

17. A method, comprising:
assigning a unique identifier to a content descriptor file;
broadcasting the content descriptor file identified by the unique identifier to one or more clients, wherein the content descriptor file is recognized by each client as a content descriptor file in response to the unique identifier assigned to the content descriptor file.

18. The method of claim 17 wherein the one or more clients are included in a segment, the segment defined as one or more clients of a subset based on one of geography, network connection or rights vectors.

19. The method of claim 17 further comprising generating the content descriptor file with content descriptors prior to broadcasting the content descriptor file.

20. A method, comprising:
receiving a file broadcast by a server;
identifying the file as a content descriptor file by a unique identifier assigned to the file;
storing the file at a content descriptor file location at a client in response to the unique identifier;
processing the content descriptor file to generate demand data feedback to be provided to the server.

21. The method of claim 20 further comprising allocating a buffer to receive the file while the file is received from the server.

22. The method of claim 21 further comprising:
locking a previously received content descriptor file after a content descriptor file is completely received; and
replacing the previously received content descriptor file with the completely received content descriptor file.

23. The method of claim 20 wherein the generation of the demand data feedback comprises the generation of ranking feedback.

24. The method of claim 20 wherein the generation of the demand data feedback comprises the generation of rating feedback.

25. A method, comprising:
assigning a general purpose identifier to a content descriptor file;
broadcasting the content descriptor file identified by the general purpose identifier to one or more clients;
broadcasting a signal to said one or more clients to indicate that the content descriptor file has been broadcast to said one or more clients, the signal to indicate to said one or more clients how to locate said content descriptor file.

26. The method of claim 25 wherein broadcasting the content descriptor file comprises broadcasting the content descriptor schedule signal using a signaling protocol including one of internet protocol (IP), digital video broadcast signal (DVB) or program and system information protocol (PSIP).

27. The method of claim 25 wherein broadcasting the signal comprises embedding the signaling a file that is broadcast.

28. A method, comprising:
receiving a content descriptor file broadcast by a server, the content descriptor file having a general purpose identifier;
receiving a signal broadcast by the server, the signal indicating that a content descriptor file has been broadcast, the signal indicating how to locate the content descriptor file;
processing the content descriptor file to generate demand data feedback to be provided to the server.

29. The method of claim 28 wherein receiving the signal broadcast by the server indicating that a content descriptor file has been broadcast comprises receiving the signal using a signaling protocol including one of internet protocol (IP), digital video broadcast signal (DVB) or program and system information protocol (PSIP).

30. The method of claim 28 wherein receiving the signal broadcast by the server indicating that a content descriptor file has been broadcast comprises receiving the signal embedded in a file that is broadcast.

31. The method of claim 28 wherein the generation of the demand data feedback comprises the generation of ranking feedback.

32. The method of claim 28 wherein the generation of the demand data feedback comprises the generation of rating feedback.

33. An article of manufacture, comprising:
a machine-readable medium having instructions to:
receive a content descriptor schedule signal broadcast by a server, the content descriptor schedule signal to indicate that a content descriptor file is to be broadcast at a broadcast time;
receive the content descriptor file at the broadcast time;
process the content descriptor file to generate demand data feedback to be provided to the server.

34. The article of manufacture of claim 33 wherein the machine-readable medium further has instructions to notify a process in a client system to process the content descriptor file received at the broadcast time.

35. The article of manufacture of claim 33 wherein the machine-readable medium further has instructions to determine how to locate the content descriptor file in response to content descriptor schedule signal.

36. An article of manufacture, comprising:
a machine-readable medium having instructions to:
receive a content descriptor schedule signal broadcast by a server, the content descriptor schedule signal to indicate that a content descriptor file is to be broadcast after a first file is broadcast;
receive the first file broadcast by the server; and
receive the content descriptor file broadcast by the server after the broadcast of the first file;
process the content descriptor file to generate demand data feedback to be provided to the server.

37. The article of manufacture of claim 36 wherein the machine-readable medium further has instructions to determine how to locate the content descriptor file in response to content descriptor schedule signal.

38. The article of manufacture of claim 37 wherein the content descriptor file is located based on one of frequency, Internet protocol (IP) port or IP address.

39. An article of manufacture, comprising:
a machine-readable medium having instructions to:
receive a file broadcast by a server;
identify the file as a content descriptor file by a unique identifier assigned to the file;
store the file at a content descriptor file location at a client in response to the unique identifier;
process the content descriptor file to generate demand data feedback to be provided to the server.

40. The article of manufacture of claim 39 wherein the machine-readable medium further has instructions to:
allocate a temporary buffer for the content descriptor file to be buffered while being received;
locking a previous version of the content descriptor file after the content descriptor file is buffered;
replacing contents of the previous version of the content descriptor file with the buffered content descriptor file.

41. The article of manufacture of claim 39 wherein the machine-readable medium further has instructions to generate demand data feedback related to files stored at the content descriptor file location.

42. An article of manufacture, comprising:
a machine-readable medium having instructions to:
receive a content descriptor file broadcast by a server, the content descriptor file having a general purpose identifier;
receive a signal broadcast by the server, the signal indicating that a content descriptor file has been broadcast, the signal indicating how to locate the content descriptor file;
process the content descriptor file to generate demand data feedback to be provided to the server.

43. The article of manufacture of claim 42 wherein the machine-readable medium includes instructions to receive the content descriptor file broadcast by the server in a same manner as other files broadcast by the server.

44. The article of manufacture of claim 42 wherein the machine-readable medium further has instructions to signal a client process that is responsible for processing the content descriptor file to generate the demand data feedback to be provided to the server.

45. An apparatus, comprising:
a processor having circuitry to execute instructions;
a communications interface coupled to the processor, the communications interface coupled to receive broadcasts from a server;
a storage device coupled to the processor, having instructions stored therein, which when executed cause the apparatus to:
receive a content descriptor schedule signal broadcast by a server, the content descriptor schedule signal to indicate that a content descriptor file is to be broadcast at a broadcast time;
receive the content descriptor file at the broadcast time;
process the content descriptor file to generate the demand data feedback to be provided to the server.

46. The apparatus of claim 45, wherein the apparatus is further caused to notify a process in the apparatus to process the content descriptor file received at the broadcast time.

47. The apparatus of claim 45, wherein the apparatus is further caused to receive the content descriptor schedule signal utilizing a signaling protocol including Internet protocol (IP), digital video broadcast (DVB) or program and system information protocol (PSIP).

48. An apparatus, comprising:
a processor having circuitry to execute instructions;
a communications interface coupled to the processor, the communications interface coupled to receive broadcasts from a server;
a storage device coupled to the processor, having instructions stored therein, which when executed cause the apparatus to:
receive a content descriptor schedule signal broadcast by a server, the content descriptor schedule signal to indicate that a content descriptor file is to be broadcast after a first file is broadcast;
receive the first file broadcast by the server; and
receive the content descriptor file broadcast by the server after the broadcast of the first file;
process the content descriptor file to generate the demand data feedback to be provided to the server.

49. The apparatus of claim 48, wherein the apparatus is further caused to determine how to locate the content descriptor file in response to content descriptor schedule signal.

50. The apparatus of claim 48, wherein the apparatus is further caused to locate the content descriptor based on one of frequency, Internet protocol (IP) port or IP address.

51. An apparatus, comprising:
a processor having circuitry to execute instructions;
a communications interface coupled to the processor, the communications interface coupled to receive broadcasts from a server;
a storage device coupled to the processor, having instructions stored therein, which when executed cause the apparatus to:
receive a file broadcast by a server;
identify the file as a content descriptor file by a unique identifier assigned to the file;
store the file at a content descriptor file location at a client in response to the unique identifier;
process the content descriptor file to generate the demand data feedback to be provided to the server.

52. The apparatus of claim 51, wherein the apparatus is further caused to:
allocate a temporary buffer for the content descriptor file to be buffered while being received;
locking a previous version of the content descriptor file after the content descriptor file is buffered;
replacing contents of the previous version of the content descriptor file with the buffered content descriptor file.

53. The apparatus of claim 51 wherein the apparatus is further caused to generate the demand data feedback based on processing on files stored at the content descriptor file location.

54. An apparatus, comprising:
a processor having circuitry to execute instructions;
a communications interface coupled to the processor, the communications interface coupled to receive broadcasts from a server;
a storage device coupled to the processor, having instructions stored therein, which when executed cause the apparatus to:
receive a content descriptor file broadcast by a server, the content descriptor file having a general purpose identifier;
receive a signal broadcast by the server, the signal indicating that a content descriptor file has been broadcast, the signal indicating how to locate the content descriptor file;
process the content descriptor file to generate demand data feedback to be provided to the server.

55. The apparatus of claim 54 wherein the apparatus is further caused to receive the content descriptor file broadcast by the server in a same manner as other files broadcast by the server.

56. The apparatus of claim 54 wherein the apparatus is further caused to signal a process in the apparatus that is responsible for processing the content descriptor file to generate the demand data feedback to be provided to the server.

57. An apparatus, comprising:
a processor having circuitry to execute instructions;
a communications interface coupled to the processor, the communications interface coupled to receive communications from one or more clients;
a storage device coupled to the processor, having instructions stored therein, which when executed cause the apparatus to:
broadcast a content descriptor schedule signal to one or more clients to indicate that a content descriptor file is to be broadcast to said one or more clients at a broadcast time;
broadcast the content descriptor file to said one or more clients at the broadcast time.

58. The apparatus of claim 57 wherein the apparatus is further caused to embed the content descriptor schedule signal within a file that is broadcast.

59. The apparatus of claim 57 wherein the apparatus is further caused to generate the content descriptor file prior to broadcasting the content descriptor file.

60. An apparatus, comprising:
a processor having circuitry to execute instructions;
a communications interface coupled to the processor, the communications interface coupled to receive communications from one or more clients;
a storage device coupled to the processor, having instructions stored therein, which when executed cause the apparatus to:
broadcast a content descriptor schedule signal to one or more clients to indicate that a content descriptor file is to be broadcast to said one or more clients after a first file is broadcast;
broadcast the first file to said one or more clients; and
broadcast the content descriptor file to said one or more clients after the first file is broadcast to said one or more clients.

61. The apparatus of claim 60 wherein the apparatus is further caused to broadcast the content descriptor schedule signal using a signaling protocol including one of internet protocol (IP), digital video broadcast signal (DVB) or program and system information protocol (PSIP).

62. The apparatus of claim 60 wherein the apparatus is further caused to broadcast the content descriptor schedule signal in a file.

63. An apparatus, comprising:
a processor having circuitry to execute instructions;
a communications interface coupled to the processor, the communications interface coupled to receive communications from one or more clients;
a storage device coupled to the processor, having instructions stored therein, which when executed cause the apparatus to:
assigning a unique identifier to a content descriptor file;
broadcasting the content descriptor file identified by the unique identifier to one or more clients, wherein the content descriptor file is recognized by each client as a content descriptor file in response to the unique identifier assigned to the content descriptor file.

64. The apparatus of claim 63 wherein the apparatus is further caused to broadcast the content descriptor file to the one or more clients organized by segments, each segment defined as one or more clients of a subset based on one of geography, network connection or rights vectors.

65. The apparatus of claim 63 wherein the apparatus is further caused to generate the content descriptor file with content descriptors prior to broadcasting the content descriptor file.

66. An apparatus, comprising:
a processor having circuitry to execute instructions;
a communications interface coupled to the processor, the communications interface coupled to receive communications from one or more clients;
a storage device coupled to the processor, having instructions stored therein, which when executed cause the apparatus to:
assigning a general purpose identifier to a content descriptor file;
broadcasting the content descriptor file identified by the general purpose identifier to one or more clients;
broadcasting a signal to said one or more clients to indicate that the content descriptor file has been broadcast to said one or more clients, the signal to indicate to said one or more clients how to locate said content descriptor file.

67. The apparatus of claim 66 wherein the apparatus is further caused to broadcast the content descriptor schedule signal using a signaling protocol including one of internet protocol (IP), digital video broadcast signal (DVB) or program and system information protocol (PSIP).

68. The apparatus of claim 66 wherein the apparatus is further caused to embed the content descriptor file in a file that is broadcast.

69. A system, comprising:
a server;
one ore more clients coupled to the server;
wherein the server is coupled to broadcast a content descriptor schedule signal to the one or more clients to indicate that a content descriptor file is to be broadcast to the one or more clients at a broadcast time;
wherein the one or more clients are coupled to receive the content descriptor schedule signal broadcast by the server;
wherein the server is coupled to broadcast the content descriptor file to the one or more clients at the broadcast time;
wherein the one or more clients are coupled to receive the content descriptor file at the broadcast time and process the content descriptor file to generate the demand data feedback to be provided to the server.

70. The system of claim 69 wherein the server is coupled to broadcast the content descriptor schedule signal embedded within a file that is broadcast.

71. The system of claim 69 wherein the server is coupled to broadcast the content descriptor schedule signal using a signaling protocol including one of internet protocol (IP), digital video broadcast signal (DVB) or program and system information protocol (PSIP).

72. A system, comprising:
a server;
one ore more clients coupled to the server;
wherein the server is coupled to broadcast a content descriptor schedule signal to the one or more clients to indicate that a content descriptor file is to be broadcast to said one or more clients after a first file is broadcast;
wherein the one or more clients is coupled to receive the receive the content descriptor schedule signal broadcast by a server;
wherein the server is coupled to broadcast the first file to said one or more clients;
wherein the one or more clients are coupled to receive the first file broadcast by the server;
wherein the server is coupled to broadcast the content descriptor file to said one or more clients after the first file is broadcast to said one or more clients;
wherein the one or more clients are coupled to receive the content descriptor file broadcast by the server after the broadcast of the first file and process the content descriptor file to generate the demand data feedback to be provided to the server.

73. The system of claim 72 wherein the one or more clients are coupled to locate the content descriptor file based in information included in the content descriptor schedule signal.

74. The system of claim 72 wherein the one or more clients are coupled to locate the content descriptor file based in information included in the content descriptor schedule signal including one of a frequency, an internet protocol (IP) port or an IP address.

75. A system, comprising:
a server;
one ore more clients coupled to the server;
wherein the server is coupled to assign a unique identifier to a content descriptor file;
wherein the server is coupled to broadcast the content descriptor file identified by the unique identifier to the one or more clients,
wherein the one or more clients are coupled to receive the content descriptor file, wherein the content descriptor file is recognized by each client as a content descriptor file in response to the unique identifier assigned to the content descriptor file;
wherein the one or more clients are coupled to store the content descriptor file at a content descriptor file location at each respective client in response to the unique identifier and process the content descriptor file to generate the demand data feedback to be provided to the server.

76. The system of claim 75 wherein the one or more clients are coupled to:
allocate buffers to receive the content descriptor file while the file is received from the server;
lock a previously received content descriptor file after the content descriptor file is completely received; and
replace the previously received content descriptor file with the completely received content descriptor file.

77. The system of claim 75 wherein the server is coupled to broadcast the content descriptor file to the one or more clients organized by segments, wherein each segment is defined as one or more clients of a subset based on one of geography, network connection or rights vectors.

78. A system, comprising:
a server;
one ore more clients coupled to the server;
wherein the server is coupled to assign a general purpose identifier to a content descriptor file;
wherein the server is coupled to broadcast the content descriptor file identified by the general purpose identifier to the one or more clients;
wherein the one or more clients are coupled to receive the content descriptor file having the general purpose identifier;
wherein the server is coupled to broadcast a signal to said one or more clients to indicate that the content descriptor file has been broadcast to said one or more clients;
wherein the one more clients are coupled to receiver the signal indicating that the content descriptor file has been broadcast, the signal to indicate to said one or more clients how to locate said content descriptor file, the one or more clients to process the content descriptor file to generate the demand data feedback to be provided to the server.

79. The system of claim 78 wherein the server is coupled to broadcast the signal using a signaling protocol including one of internet protocol (IP), digital video broadcast signal (DVB) or program and system information protocol (PSIP).

80. The system of claim 78 wherein the client is coupled to broadcast the signal by embedding the signal in a file that is broadcast to the one or more clients.
